(19) United States
(12) Patent Application Publication
(10) Pub. No.: US 2018/0220856 A1
(43) Pub. Date: Aug. 9, 2018

(54) IMPROVED VERMICOMPOSTING TOILET FACILITY

(71) Applicant: SANISPHERE, Saint-Ferreol-Trente-Pas (FR)

(72) Inventor: Pierre COLOMBOT, Saint-Ferreol-Trente-Pas (FR)

(73) Assignee: SANISPHERE, Saint-Ferreol-Trente-Pas (FR)

(21) Appl. No.: 15/750,884

(22) PCT Filed: Aug. 25, 2016
(86) PCT No.: PCT/FR2016/052119

§ 371 Date: Feb. 7, 2018

(30) Foreign Application Priority Data
Aug. 28, 2015 (FR) 15 57987

(51) Int. Cl. A47K 11/02; C05F 17/00; C05F 17/02

(52) U.S. Cl. CPC A47K 11/02; C05F 17/0009; C05F 17/0264; C05F 17/0211; C05F 17/0258

(57) ABSTRACT

The invention relates to a toilet installation comprising equipment (4) presenting a gravity discharge opening (5) for liquid effluent and solid waste, and a reception system (30) for receiving liquid effluent and solid waste dropping from the gravity discharge opening (5). The installation further comprises a transport device (35) for transporting the composting medium in the form of a continuous bed of material of determined thickness and for a duration suitable for obtaining the composted medium, the transport device (35) comprising at least one support surface (36) for supporting the bed, which surface is placed under the top portion of the reception system and extends to a discharge edge (37) for discharging the composted medium dropping off said support surface.

The present invention relates to the general technical field of devices for draining, discharging, and transforming fecal matter and urine.

The invention relates more particularly to the category of so-called “dry” toilets that do not make use of an auxiliary flushing fluid and that make it possible to do without a connection to a general drainage network.

The state of the art proposes numerous variant embodiments of dry toilet installations. In general manner, such a toilet installation comprises a restroom adjacent to a treatment chamber. The restroom includes equipment such as a toilet seat or a squat toilet pan. Such equipment includes a gravity discharge opening for liquid effluent and for solid waste, such as fecal matter and toilet paper.

The liquid effluent and solid waste is discharged into the treatment chamber where it is subjected to treatment operations such as separation, composting, or vermicomposting. Numerous solutions are known for treating liquid effluent and solid waste. For example, patent FR 2 755 362 proposes using a sloping running belt above which the gravity discharge opening opens out. The sloping running belt provides gravity separation between liquid effluent, which is recovered at the bottom portion of the running belt, and solid waste, which is moved in translation by the running belt to a top portion from which it drops into a storage zone where the waste accumulates in order to form a conically-shaped heap. The heap needs to be moved manually in order to release space under the top portion of the running belt.

In order to avoid forming a conically-shaped heap of waste and thus avoid frequent maintenance operations, patent FR 2 823 201 proposes installing a scraper chain in the storage zone that serves to spread this pile of waste, which is a composting medium containing in particular fecal matter and toilet paper, and also containing worms of a variety that is suitable for transforming the waste into compost. Such a toilet installation operates properly so long as its usage does not exceed 15,000 to 20,000 uses per year. Above that usage threshold, it is found in practice that the too frequent arrival fecal matter together with its being spread disturbs the activity of vermicomposting and can even lead to the disappearance of the worms.

It thus becomes necessary at regular time intervals to spread the heap of waste manually in order to obtain good vermicomposting. That constraint requires a treatment chamber to be available that is of sufficient surface area. Thus, such dry toilets that need to possess a treatment chamber of large size are difficult to transport by road (abnormal load) and even more difficult by boat. The other solution that consists in transporting the toilet assembly as separate parts for assembly on site is extremely expensive.

The present invention seeks to remedy the drawbacks of the prior art by proposing a novel dry toilet installation designed for presenting effective vermicomposting even when the toilets are used frequently, while still being capable of being transported easily over long distances.

To achieve these objects, the present invention provides a toilet installation comprising equipment presenting a gravity discharge opening for liquid effluent and solid waste, and a reception system for receiving liquid effluent and solid waste dropping from the gravity discharge opening, the reception system extending along a sloping plane to provide gravity separation between the liquid effluent and the solid waste, a mechanical system serving to advance the solid waste towards the top portion of the reception system in order to bring it into a composting medium constituted both by solid waste as brought in in this way and also by worms of a variety suitable for transforming said waste into a composted medium. The installation comprises a transport device for transporting the composting medium in the form of a continuous bed of material of determined thickness and for a duration suitable for obtaining the composted medium, the transport device comprising at least one support surface for supporting the bed, which surface is placed under the top portion of the reception system and extends to a discharge edge for discharging the composted medium dropping off said support surface, the transport device causing the bed of material to move from under the top portion of the reception system to the discharge edge, under which there is positioned a discharge receptacle for the composted medium, the device for transporting the composting medium including a system for fastening it inside a freight container having a floor wall and a ceiling wall connected together by two side walls and an end wall located opposite from two access doors, the transport device being positioned so that the discharge edge and the portion placed under the top portion of the reception system are respectively situated closer to the access doors and closer to the end wall, the inside of the container defining the treatment chamber that is accessible via the doors of the container and that communicates with a restroom provided with the equipment solely via the gravity discharge opening.

The installation of the invention further comprises in combination any one and/or more of the following additional characteristics:
the mechanical system for causing the solid waste to advance towards the top portion of the reception system possesses a speed of advance that is greater than the speed of advance of the device for transporting the bed of material by a factor lying in the range 1000 to 20,000, and preferably in the range 5000 to 10,000;
the equipment including the gravity discharge opening is fitted with a control member for controlling the operation firstly of the mechanical system causing the solid waste to advance towards the top portion of the reception system, and secondly the device for transporting the bed of material;
the device for transporting the bed of material comprises a driven scraper chain having scraper elements co-operating with a soleplate for receiving the bed of material;
the device for transporting the bed of material comprises a movement system for moving the surface for supporting the bed of material;
the system for moving the surface for supporting the bed of material comprises a driven endless belt conveyor having a top portion defining the support surface for the bed of material, and supported by a soleplate;
the system for moving the support surface for supporting the bed of material comprises firstly a non-driven endless belt conveyor defining on one side the surface for supporting the bed of material and presenting on the opposite side a friction surface rubbing against the soleplate, and secondly a driven scraper chain having scraper elements and driven to transport the bed of material, which chain entrains movement of the endless belt by the bed of material adhering on said belt;
the soleplate and the friction surface of the endless belt conveyor possess low coefficients of friction;
the transport device includes a system for maintaining moisture suitable for keeping the worms alive and comprising a water delivery device and a device for limiting evaporation;
the restroom is defined by a cubicle having at least one access door;
the cubicle defining the restroom is formed at least in part by a wall of the container;
the container includes an air discharge chimney communicating with the treatment chamber and extending above the ceiling wall;
the chimney includes at least one transparent casing designed to heat air; and
the chimney includes internally a tube of black color to enable air to flow equally well inside the tube and between the tube and the chimney.

Various other characteristics appear from the description made below with reference to the accompanying drawings which show embodiments of the invention as non-limiting examples.

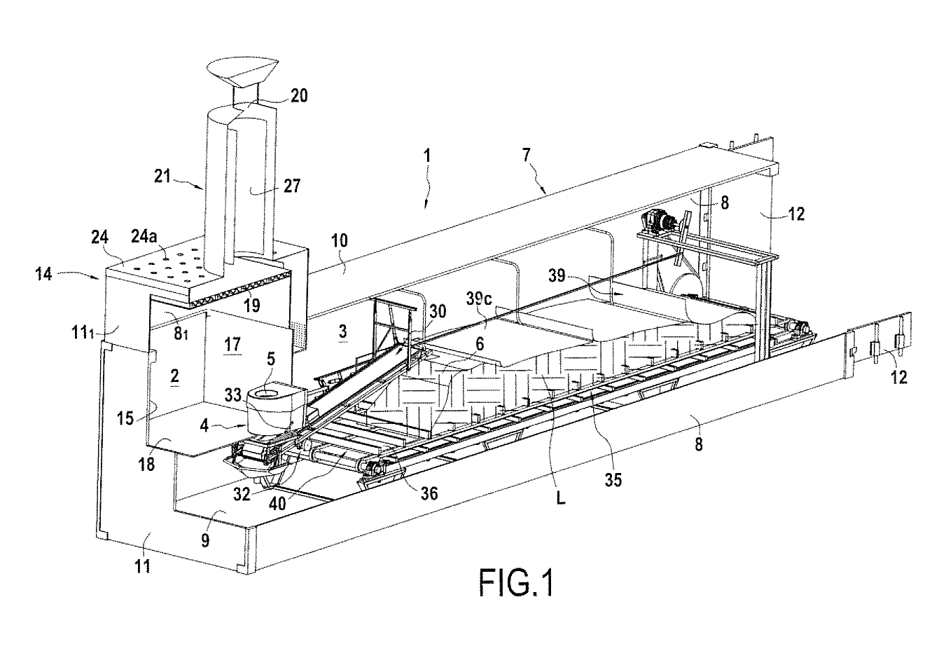

FIG. 1 is a partially cutaway perspective front three-quarter view of an embodiment of a toilet installation in accordance with the invention.

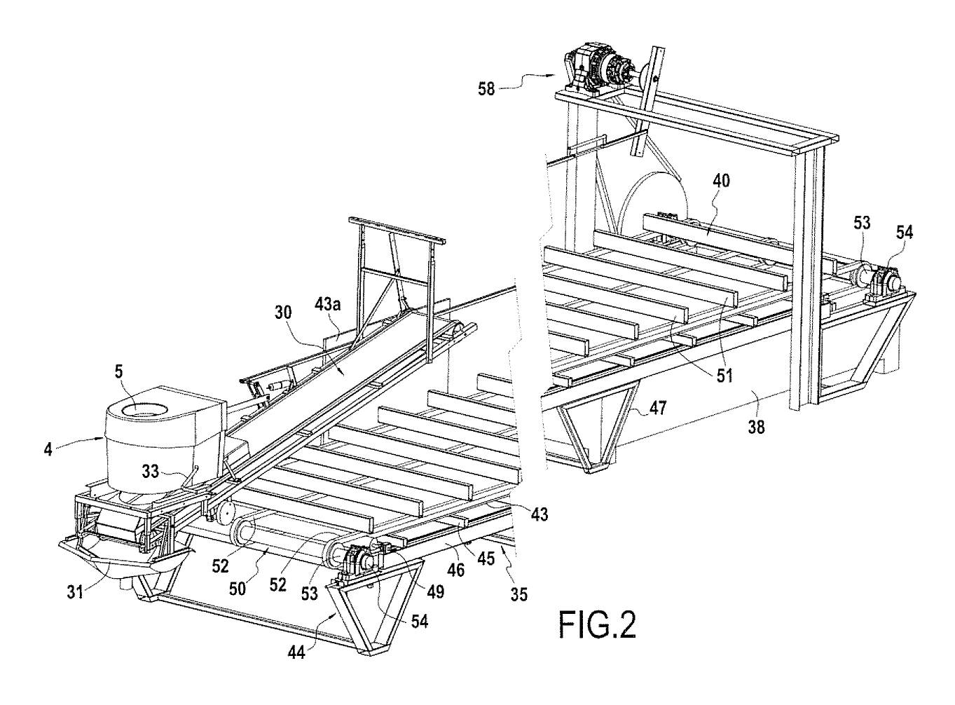

FIG. 2 is a fragmentary perspective view of the toilet installation shown in FIG. 1.

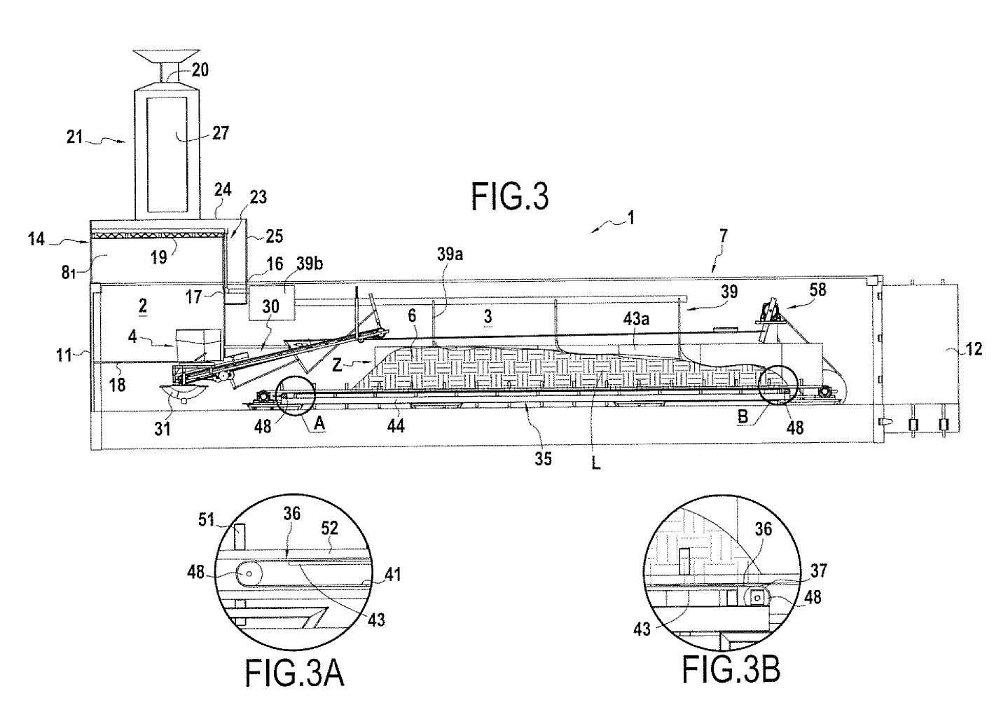

FIG. 3 is a longitudinal elevation view of the toilet installation shown in FIG. 1.

FIGS. 3A and 3B show respective details A and B of the toilet installation shown in FIG. 3.

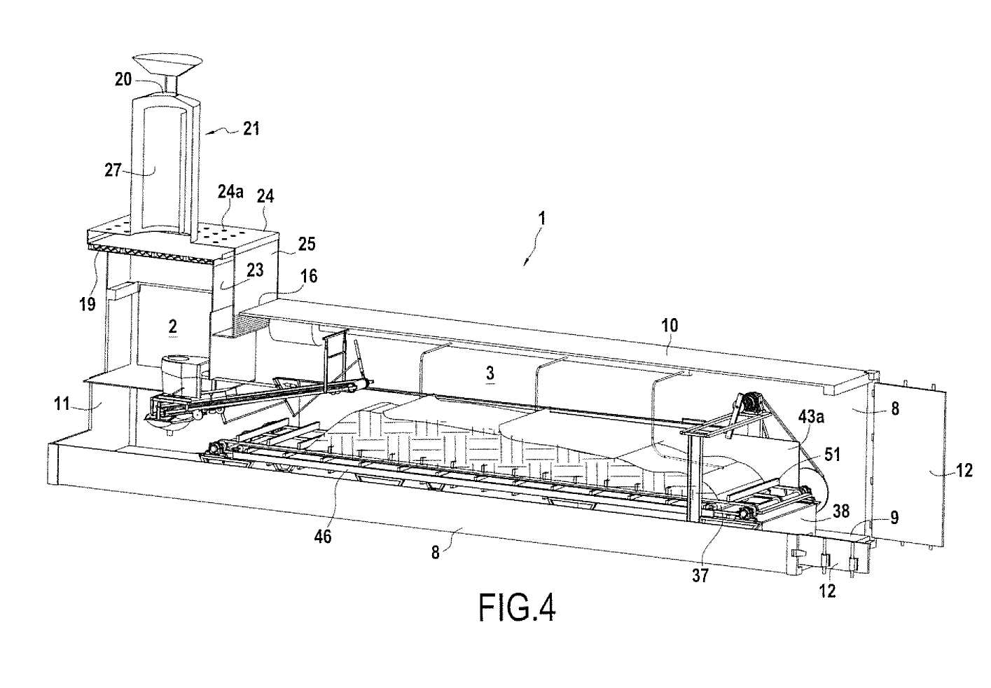

FIG. 4 is a partially cutaway three-quarter rear perspective view of an embodiment of a toilet installation in accordance with the invention.

As can be seen in the figures, the invention relates to a so-called “dry” toilet installation 1 having at least one restroom 2 (and only one in the example shown in FIGS. 1 to 3) adjacent to or placed in the proximity of a treatment chamber 3. The restroom 2 is conventionally provided with equipment 4 presenting a gravity discharge opening 5 firstly for liquid effluent such as urine and secondly for solid waste 6 made up of fecal matter and of toilet paper, in particular. Conventionally, the treatment chamber 3 recovers at least the solid waste, but generally also recovers the liquid effluent.

In the example shown in FIGS. 1 to 4, the equipment 4 is a toilet seat, however it is clear that the equipment 4 could be implemented in the form of a pan of a squat toilet.

According to a characteristic of the invention, the toilet installation 1 of the invention is in the form of a structure that can be transported by road, by rail, or by sea. Advantageously, the transportable structure comprises a 20 foot to 40 foot dry freight container 7 (i.e. having a length in the range 6 meters (m) to 12 m). Typically, the container has a width of about 2.50 m.

Conventionally, such a container 7 of the invention is generally in the form of a rectangular box and is made out of metal material. The container 7 has two opposite side walls 8 extending vertically and connected together by a floor wall 9 at the bottom and by a ceiling wall 10 at the top. The container 7 is closed at one end by a rear wall 11 and at the opposite end by two doors 12 giving access to the inside volume of the container. Thus, the container 7 serves as transport means for transporting the toilet installation, and also as a structure on the site where such a toilet installation is located. The container 7 serves in particular to transport in kit form at least some of the equipment for the restroom 2 and also the air discharge chimney as described below.

According to an advantageous characteristic of the invention, the inside of container 7 defines the treatment chamber 3, which is accessible via the container doors 12 and which communicates with the restroom 2 that is provided with the equipment 4 solely via the gravity discharge opening 5. The restroom 2 is thus separate from the treatment chamber 3, being situated at the end of the container remote from the end having the doors 12. The restroom 2 is defined by a kind of cubicle 14 enabling the restroom to be isolated from the treatment chamber. Naturally, the cubicle 14 has at least one door 15 giving access to the inside of the restroom 2.

The cubicle 14 defining the restroom 2 is made up at least in part by one of the walls of the container 7 such that the restroom 2 is contiguous with the container or is contained at least in part inside the container. In the embodiment shown in the figures, the cubicle 14 is half embedded in the container 7 in a cutout 16 formed in the ceiling wall 10 and extending from the rear wall 11. In this example, the cubicle 14 is formed by portions of the side walls 8 that are extended by fitted side partitions 8₁ and by a portion of the rear wall 11 of the container that is extended by a rear partition 11₁. The cubicle 14 also has a separating partition 17 situated facing the rear wall 11 and between the side walls 8. The four sides of the cubicle 14 are closed at the bottom by a floor 18 and at the top by a ceiling 19. The access door 15 to the restroom is provided by making a cutout in the rear wall 11 of the container.

In the example shown, the cubicle 14 projects relative to the ceiling wall 10 of the container. It should be observed that the cubicle 14 could be made to extend entirely from the ceiling wall 10 of the container such that the floor 18 is situated at the same level as the ceiling wall 10. In such an embodiment, the cubicle 14 is fitted and fastened on the ceiling wall 10 in which at least the gravity discharge opening 5 is arranged. It should be observed that in order to transport the toilet installation, the cubicle 14 is separated and placed inside the container in order to be put into place only once the container is in its final location. Thus, during transport, the size occupied by the toilet installation corresponds to the size of the container 7.

In another embodiment that is not shown, the restroom 2 is arranged entirely inside the container 7. In this example, the container 7 is provided with the separating partition 17 in order to separate the restroom 2 from the treatment chamber 3. The rear wall 11 is provided with at least one door 15 giving access to said restroom 2.

As can be seen from the above description, the restroom 2 communicates with the treatment chamber 3 so that the treatment chamber has a single air inlet made by the gravity discharge opening 5 from the equipment in the restroom 2. In other words, the only inlet for air into the treatment chamber 3 takes place through the toilet seat or the opening in the floor when using squat toilets.

In the embodiment shown, the gravity discharge opening 5 communicates with the treatment chamber 3 by passing through the floor 18 which also serves to separate the treatment chamber 3 from the restroom 2. It should be understood that the equipment 4 is mounted in airtight manner and in any manner appropriate for ensuring that the treatment chamber 3 has as its air inlet solely the gravity discharge opening 5 from the equipment 4.

According to another characteristic of the installation 1 of the invention, the treatment chamber 3 has a single air outlet 20. The air outlet 20 is arranged at an altitude that is determined in such a manner as to obtain a considerable difference in height relative to the level of the air inlet 5 into the treatment chamber, and preferably a difference that is as large as possible in order to obtain an upward flow of air between the inlet 5 and the air outlet 20 so as to ensure good dispersion of the odors present in the discharged air.

In the embodiment shown in the drawings, the air outlet 20 is provided via a chimney 21 that projects above the ceiling 19 of the restroom and is in communication with the treatment chamber via a duct 23 formed between the ceiling 19 and a roof 24 that extends at a distance from the ceiling 19 and that is extended at right angles by a closure panel 25 spaced apart from and facing a portion of the separating partition 17. Air thus flows from the restroom 2 into the treatment chamber 3 by passing through the gravity discharge opening 5, and it leaves the treatment chamber 3 via the air outlet 20 after passing through the duct 23 and the chimney 21. Naturally, the restroom 2 has an air inlet in order to make such flow possible. In another embodiment, the air outlet 20 is made at the top end of an air discharge chimney 21 communicating with the treatment chamber 3 and extending in the form of a tube above the ceiling wall 10 of the container.

It should be understood that the treatment chamber 3 is at least airtight and has a single air inlet constituted by the gravity discharge opening 5 and a single air outlet 20. Naturally, the airtightness of the treatment chamber 3 is relative, but appropriate for obtaining the flow of air from the inlet to the outlet. Advantageously, if the treatment chamber 3 is fluid-tight so as to be watertight in particular, it should be observed that the treatment chamber 3 is provided by way of example in its floor wall 9 with holes that allow water to enter in the event of an accidental rise in the level of water in the ground in which the container is buried.

In an advantageous embodiment variant, the roof 24 is made of a transparent material and the outside face of the ceiling is provided with a black coating so as to encourage air temperature to rise, thereby contributing to causing air to flow between the air inlet and the air outlet 20. This natural convection phenomenon may be associated additionally with the chimney being made of transparent material and with a tube 27 of black color being placed inside the chimney, the tube being of dimensions that are adapted to allow air to flow equally well inside the tube 27 and between the tube and the chimney 21.

The installation 1 of the invention includes a reception system 30 for receiving liquid effluent and solid waste dropping through the gravity discharge opening 5. The reception system 30 is mounted in the treatment chamber 3, extending on a sloping plane so as to provide gravity separation between the liquid effluent and the solid waste. In a preferred embodiment as shown more particularly in FIG. 2, the reception system 30 is made with a running belt placed under the gravity discharge opening 5. The reception system 30 serves to provide gravity separation between the liquid effluent that is recovered in the bottom portion of the running belt by any appropriate means 31.

The installation 1 of the invention also includes a mechanical system 32 for advancing the solid waste towards the top portion of the reception system 30 so as to bring it towards a storage zone Z for storing a composting medium constituted both by the solid waste as delivered in this way and also by worms of a variety suitable for transforming said waste, such as eisenia fetida worms. In the preferred embodiment, this mechanical movement system 32 comprises a control pedal 33 acting via a transmission, which is not described but which is itself known, to cause the running belt to advance and consequently to move the solid waste 6 towards the top portion of the running belt. The solid waste thus drops from the top portion of the running belt into the storage zone Z.

In the described preferred embodiment, the reception system 30 is made by a sloping running belt that is advanced under the control of the pedal 33. It should be observed that provision may be made in another embodiment for this reception system 30 to be constituted by a stationary sloping surface. In such an embodiment, the movement system 32 comprises a scraper chain having scraper elements co-operating with the stationary sloping surface so as to entrain the solid waste to the top portion of the stationary sloping surface. The scraper chain is controlled to move by the actuator pedal 33.

According to a characteristic of the invention, the toilet installation 1 has a device 35 for transporting the composting medium in the form of a bed L of material having a determined height and for a duration that is appropriate in order to obtain the composted medium. The transport device 35 comprises at least one support surface 36 for the bed L of material, placed under the top portion of the reception system 30 and extending to an edge 37 for discharging the composted medium by dropping it from said support surface. The transport device 35 thus moves the bed L of material, from under the top portion of the reception system 30 to the discharge edge 37 of the transport device 35.

The bed L of material presents a continuous structure over its entire length from under the top portion of the reception system 30 to the discharge edge 37. This continuous bed L of material, which is supported by the surface 36, forms a single block of material that is moved as a block by the transport device 35. The thickness of this bed of material varies as a function of the degree of composting.

The composted medium drops from the discharge edge 37 below which there is positioned a composted medium discharge receptacle 38, such a receptacle 38 being provided with wheels. The composted medium recovered by the receptacle 38 is discharged by any appropriate means through the nearby doors 12 of the container.

The transport device 35 serves to disengage the bed of material from under the top portion of the reception system 30 so that the portion of the bed of material that is disengaged is no longer fed with fresh waste dropping from the reception system 30. The worms that are present in the bed of material can thus transform the waste into compost without being disturbed by the arrival of recent waste presenting intense microbial life.

Advantageously, the residence time of the waste on the surface of the support 36 is adapted to obtain a composted medium by the time the bed of material reaches the discharge edge 37. Typically, the residence time of the waste on the support surface 36 lies in the range one year to five years, and preferably lies in the range two years to three years. The waste is stored on the support surface in a continuous bed of material having thickness lying in the range 20 centimeters (cm) to 1 meter (m).

The waste stored on the support surface 36 remains moist throughout the duration of the vermicomposting operation. According to an advantageous embodiment characteristic, the transport device 35 has a system 39 for maintaining appropriate moisture for keeping the worms alive. In the example shown, the moisture maintaining system 39 has a water delivery device 39a, preferably for delivering rain water, that is arranged at a plurality of spaced-apart locations above the bed L of material, using a drip system, for example, or by a circuit that is fed from a tank 39b that discharges quickly each time its water level reaches a given setpoint. For example, the tank 39b may be fed with rain water recovered by the ceiling 19 and passing through the ceiling roof 24 via holes 24a formed in the roof. In the example shown, the moisture maintaining system 39 also has a device 39c for limiting evaporation, e.g. constituted by suspended flexible plastics sheets that come into contact with the bed of material. It should be observed that such an evaporation limiting system adapts automatically to the thickness of the bed of material.

In the embodiment shown in the drawings, the transport device 35 for transporting the bed of material comprises a movement system 40 for moving the support surface 36 supporting the bed of material. In other words, the surface 36 that supports the bed L of material is movable in translation from under the reception system 30 towards the discharge edge 37. As can be seen in FIGS. 3A and 3B, the movement system 40 of the support surface 36 supporting the bed of material comprises an endless belt conveyor 41 that is not driven, having a top strand that defines on its outside the support surface 36 for supporting the bed of material and presenting on its inside a friction surface rubbing against a soleplate 43 supported by a carrier structure 44.

It should be observed that, on both sides of the soleplate 43, walls 43a rise vertically serving to hold the waste transversely on the support surface 36. The top strand of the endless belt conveyor 41 thus passes between the two vertical walls 43a.

In the element shown, this carrier structure 44 has cross-members 45 supporting the soleplate 43 and the walls 43a, each of them being fastened at its neighboring ends to two length-members 46 extending parallel to each other and to the side walls 8 of the container. These length-members 46 are supported by stands 47 rigidly anchored on the floor wall 9 of the container, by any conventional fastener system.

The endless belt 41 is mounted freely between two rollers 48 on shafts that are supported by bearings 49 carried by the carrier structure 44. The discharge edge 47 for discharging the bed of material is thus constituted by the endless belt 41 passing over the roller 48 that is furthest away from the gravity discharge opening 5. It should be understood that this endless belt 41 is mounted freely between these two rollers 48, with the top strand that receives the bed L of material being supported by the soleplate 43.

The movement system 40 also has a driven scraper chain 50 carrying scraper elements 51. For example, the scraper chain 50 comprises at least two endless chains 52 passing between two shafts 53 supported by bearings 54 mounted on the carrier structure 44. The scraper elements 51 are fastened at regular intervals to the two endless chains 52. These two endless chains 52 are mounted so that the scraper elements 51 carried by the top strands of the two endless chains 52 are positioned a little above the top strand of the non-driven endless belt conveyor 41 (FIG. 3A).

This scraper chain 50 is driven by a movement system 58 so as to move the bed of material, which in turn entrains movement of the endless belt 41 by adhesion between the bed of material and said belt. Specifically, it should be understood that the bed L of material adheres to the endless belt 41. This bed L of material is pushed by the scraper chain 50 so that the endless belt 41, which is mounted to move freely, is moved in translation away from the gravity discharge opening. This endless belt 41 constitutes a skid in contact with the soleplate 43 and serves to reduce opposing forces.

In order to facilitate advancing the transport device 35, the soleplate 43 and the friction surface of the endless belt 41 have low coefficients of friction. For example, the endless belt 41 may be made out of a material known under the trade name Kevlar associated with polytetrafluoroethylene (PTFE), while the soleplate may be made of polyethylene.

According to an advantageous embodiment characteristic, the system 32 for causing the solid waste to advance towards the top portion of the reception system 30 possesses a speed of advance that is greater than the speed of advance of the transport device 35 for moving the bed of material by a factor lying in the range 1000 to 20,000, and preferably in the range 5000 to 10,000. In other words, the speed of advance of the bed L of material is much slower than the speed of advance of waste situated on the reception system 30.

In this preferred embodiment variant, the mechanical advance system 32 and the transport device 35 are caused to move by a common control member, namely the control pedal 33 fitted to the equipment 4.

Thus, the equipment 4 including the gravity discharge opening 5 is fitted with a control member 33 that controls the operation firstly of the mechanical system 32 serving to cause solid waste to advance towards the top of the reception system 30, and secondly the device 35 for transporting the bed of material. Thus, the member 33, such as a control pedal, serves to control movement both of waste situated on the reception system 30 and of the bed L of material carried by the transport device 35.

Given the difference in movement speeds between the mechanical advance system 32 and the transport device 35, the movement system 58 that serves to move the bed of material includes a reduction system interposed between the control pedal 33 and one of the shafts 53 of the scraper chain 50 that is driven in this way.

In the example shown in the drawings, the movement system 40 for moving the support surface 36 supporting the bed of material comprises firstly the non-driven endless belt conveyor 41 and the driven scraper chain 50. Naturally, the movement system 40 for moving the support surface 36 supporting the bed of material may be embodied in some other way. Thus, the movement system 40 for moving the support surface 36 for supporting the bed of material may include a driven endless belt conveyor having its top portion that defines the support surface 36 for supporting the bed of material that is sequenced by the soleplate. In this example, the endless belt conveyor is caused to move by a mechanical transmission controlled by the pedal 33.

In another embodiment example, the transport device 35 for transporting the bed L of material includes a driven scraper chain 50 having scraper elements co-operating with the soleplate 43 for receiving the bed of material. In this example, the driven scraper chain 50 is caused to move by a mechanical transmission controlled by the pedal 33.

The invention is not limited to the examples described and shown, since various modifications may be made thereto without going beyond its ambit.

1. A toilet installation comprising, in a restroom (2), equipment (4) presenting a gravity discharge opening (5) for liquid effluent and solid waste, the installation comprising, in a treatment chamber (3), a reception system (30) for receiving liquid effluent and solid waste dropping from the gravity discharge opening (5), the reception system (30) extending along a sloping plane to provide gravity separation between the liquid effluent and the solid waste, a mechanical system (32) serving to advance the solid waste towards the top portion of the reception system (30) in order to bring it into a composting medium constituted both by solid waste as brought in in this way and also by worms of a variety suitable for transforming said waste into a composted medium, the installation being characterized in that it comprises a transport device (35) for transporting the composting medium in the form of a continuous bed (L) of material of determined thickness and for a duration suitable for obtaining the composted medium, the transport device (35) comprising at least one support surface (36) for supporting the bed, which surface is placed under the top portion of the reception system and extends to a discharge edge (37) for discharging the composted medium dropping off said support surface, the transport device (35) causing the bed (L) of material to move from under the top portion of the reception system (30) to the discharge edge (37), under which there is positioned a discharge receptacle (38) for the composted medium, the device (35) for transporting the composting medium including a system for fastening it inside a freight container (7) having a floor wall (9) and a ceiling wall (10) connected together by two side walls (8) and an end wall (11) located opposite from two access doors (12), the transport device (35) being positioned so that the discharge edge (37) and the portion placed under the top portion of the reception system (30) are respectively situated closer to the access doors (12) and closer to the end wall (11), the inside of the container (7) defining the treatment chamber (3) that is accessible via the doors (12) of the container and that communicates with the restroom (2) solely via the gravity discharge opening (5).

2. The toilet installation according to claim 1, wherein the mechanical system (32) for causing the solid waste to advance towards the top portion of the reception system (30) possesses a speed of advance that is greater than the speed of advance of the device (35) for transporting the bed of material by a factor lying in the range 1000 to 20,000, and preferably in the range 5000 to 10,000.

3. The toilet installation according to claim 1, wherein the equipment (4) including the gravity discharge opening (5) is fitted with a control member (33) for controlling the operation firstly of the mechanical system (32) causing the solid waste to advance towards the top portion of the reception system, and secondly the device (35) for transporting the bed of material.

4. The toilet installation according to claim 1, wherein the device (35) for transporting the bed (L) of material comprises a driven scraper chain (50) having scraper elements (51) co-operating with a soleplate (43) for receiving the bed of material.

5. The toilet installation according to claim 1, wherein the device (35) for transporting the bed of material comprises a movement system (40) for moving the surface (36) for supporting the bed of material.

6. The toilet installation according to claim 5, wherein the system (40) for moving the surface (36) for supporting the bed of material comprises a driven endless belt conveyor having a top portion defining the support surface for the bed of material, and supported by a soleplate (43).

7. The toilet installation according to claim 5, wherein the system (40) for moving the support surface (36) for supporting the bed of material comprises firstly a non-driven endless belt conveyor (41) defining on one side the surface (36) for supporting the bed of material and presenting on the opposite side a friction surface rubbing against the soleplate (43), and secondly a driven scraper chain (50) having scraper elements (51) and driven to transport the bed of material, which chain entrains movement of the endless belt by the bed of material adhering on said belt.

8. The toilet installation according to claim 7, wherein the soleplate (43) and the friction surface of the endless belt conveyor (41) possess low coefficients of friction.

9. The toilet installation according to claim 1, wherein the transport device (35) includes a system (29) for maintaining moisture suitable for keeping the worms alive and comprising a water delivery device (39a) and a device (39c) for limiting evaporation.

10. The toilet installation according to any one of claim 1, wherein the restroom (2) is defined by a cubicle (14) having at least one access door (15).

11. The toilet installation according to claim 10, wherein the cubicle (14) defining the restroom (2) is formed at least in part by a wall of the container (7).

12. The toilet installation according to claim 1, wherein the container (7) includes an air discharge chimney (21) communicating by the gravity discharge opening (5) with the treatment chamber (3) and rising above the ceiling wall (10).

13. The toilet installation according to claim 12, wherein the chimney (21) includes at least one transparent casing designed to heat air.

14. The toilet installation according to claim 12, wherein the chimney (21) includes internally a tube (27) of black color to enable air to flow equally well inside the tube (27) and between the tube and the chimney (21).
